(19) United States
(12) Patent Application Publication
(10) Pub. No.: US 2026/0359075 A1
(43) Pub. Date: Nov. 12, 2026

(54) USER INTERFACE AUTOMATED NAVIGATION

(71) Applicant: Microsoft Technology Licensing, LLC, Redmond, WA (US)

(72) Inventors: Zhizheng ZHANG, Redmond, WA (US); Xiaoyi ZHANG, Redmond, WA (US); Wenxuan XIE, Redmond, WA (US); Yuwang WANG, Redmond, WA (US); Yan LU, Redmond, WA (US)

(73) Assignee: Microsoft Technology Licensing, LLC, Redmond, WA (US)

(21) Appl. No.: 19/130,831

(22) PCT Filed: Nov. 7, 2023
(86) PCT No.: PCT/US2023/036970

§ 371 Date: May 16, 2025

(30) Foreign Application Priority Data
Dec. 7, 2022 (CN) 202211567251.9

(51) Int. Cl. G06F 9/451; G06F 3/04842

(52) U.S. Cl. CPC G06F 9/451; G06F 3/04842

(57) ABSTRACT

According to implementations of the present disclosure, a solution for automated navigation of user interface (UI) is provided. According to the solution, for UI elements, tokens representing the UI elements are generated. These UI elements at least include one or more UI elements in a current user interface being presented. The tokens are transformed into respective feature representations of the UI elements using at least specific information corresponding to a current navigation task. Based on the feature representations, a target element is determined for the current navigation task from the UI elements. An operation associated with the target element is performed. In this way, it helps to improve the performance of various navigation tasks by using the specific information of the navigation task.

### BACKGROUND

Various websites and applications (APP) have become common tools for transmitting information and realizing functions in work and life. The user interface (UI) of the website and APP contains rich and diverse graphic and text information. Interactions with the UI are almost indispensable for browsing websites and using applications. By completing a series of UI navigation tasks, users can perform corresponding operations and achieve multiple functions.

### SUMMARY

According to implementations of the present disclosure, there is provided a solution for UI automated navigation. In this solution, for a set of user interface elements, a set of tokens respectively representing the set of user interface elements are determined. The set of user interface elements at least include one or more user interface elements in a current user interface being presented. The set of tokens are transformed into respective feature representations of the set of user interface elements using at least specific information corresponding to a current navigation task. Based on the feature representations, a target element is determined for the current navigation task from the one or more user interface elements. An operation associated with the target element is performed. According to the implementations of the present disclosure, quantitative representations of UI elements are processed with information specific to the navigation task, thereby the information specific to the navigation task is reflected in the quantitative representations of UI elements. It helps to improve the performance of each navigation task.

This Summary is provided to introduce the selection of objects in a simplified form, which will be further described in the specific embodiments below. This part is not intended to identify the key features or main features of the subject matter to be protected, nor to limit the scope of the subject matter to be protected.

### BRIEF DESCRIPTION OF DRAWINGS

FIG. 1 shows a block diagram of an example environment in which multiple implementations of the present disclosure can be implemented;

FIG. 2 shows an example architecture for UI automated navigation according to some implementations of the present disclosure;

FIG. 3 shows an example of a predictor according to some implementations of the present disclosure;

FIG. 4 shows an example of a hybrid embedding layer in a predictor according to some implementations of the present disclosure;

FIG. 5 shows a flowchart of a process of UI automated navigation according to some implementations of the present disclosure; and

FIG. 6 shows a schematic block diagram of an electronic device that can implement various implementations of the present disclosure.

### DETAILED DESCRIPTIONS

Implementations of the present disclosure will now be discussed with reference to a number of example implementations. It is to be understood that these implementations are discussed only to enable those skilled in the art to better understand and thus implement the disclosure, rather than imply any limitation on the scope of the disclosure.

As used herein, the term “comprises” and its variants are to be interpreted as an open term meaning “comprises but is not limited to”. The term “based on” is to be read as “based at least in part on”. The terms “an implementation” and “one implementation” should be interpreted as “at least one implementation”. The term “another implementation” should be interpreted as “at least one further implementation”. The terms “first”, “second”, and the like may refer to different or identical objects. Other explicit and implicit definitions may also be comprised below.

It should be noted that the title of any section/subsection provided herein is not restrictive. The disclosure describes various implementations throughout, and any type of implementation can be included under any section/subsection. In addition, the implementation described in any section/subsection can be combined in any way with any other implementation(s) described in the same section/subsection and/or different sections/subsections.

As used herein, a set of elements, an element set or similar expressions may include one or more such elements. The set of elements can be ordered or unordered. For example, “a set of UI elements” can include one or more UI elements; and “a set of tokens” can include one or more tokens.

As used herein, the term “UI element” refers to the component of the interface that is presented to the user on the UI, which can be defined in any appropriate granularity for human-computer interactions. For example, UI elements can include but are not limited to images, texts, icons, buttons, drop-down menus, search boxes, input boxes, and so on. In some implementations, the UI elements can be an integral basic part of the UI.

As used herein, the term “UI navigation” or “navigation” refers to a guide for providing interactive guidance to users of the UI, so as to assist or replace the users in corresponding operations and achieve required functions.

As used herein, the term “model” can learn an association between corresponding inputs and outputs from training data, so that corresponding outputs can be generated for a given input after training. The model generation can be based on the machine learning technology. Deep learning (DL) is a machine learning algorithm that processes inputs and provides corresponding outputs by using multi-layer processing units. The neural network model is an example of a model based on deep learning. In this disclosure, “a model” can also be called “a machine learning model”, “a learning model”, “a machine learning network” or “a learning network”, and these terms are used interchangeably in this disclosure.

Generally, the machine learning can comprise three stages, namely, a training stage, a testing stage, and an inference stage (also known as a reasoning stage). In the training stage, a given model can be trained with a large amount of training data, and iterations can be continued until the model can obtain from the training data consistent inference that meets an expected goal. Through training, the model can be considered to be able to learn the association between inputs and outputs from the training data (also known as an input-output mapping). Parameter values of the trained model are determined. In the testing stage, a testing input is applied to the trained model to test whether the model can provide a correct output, so as to determine the performance of the model. In the inference stage, the model can be used to process an actual input and determine a corresponding output based on the parameter values obtained from the training.

### Example Environment

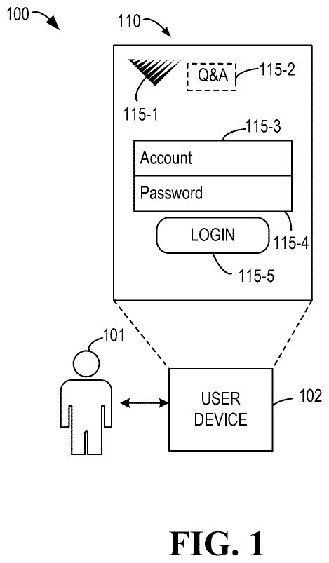

FIG. 1 shows a schematic diagram of an example environment 100 in which an implementation of the present disclosure can be implemented. In the environment 100, a user 101 completes a UI navigation task by interacting with a user device 102.

The user device 102 can be any type of a mobile device, a fixed device, or a portable device, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital/video camera, a positioning device, a TV receiver, a radio broadcast receiver, an e-book device, a game device or any combination of the foregoing, including accessories and peripherals of these devices or any combination thereof. In some implementations, the user device 102 can also support any type of user-specific interface (such as a “wearable” circuit, etc.).

One or more UIs are presented to the user 101 through the user device 102. These UIs may include web pages of websites, APP pages, document pages, etc. Each UI includes one or more UI elements. One or more UI navigation tasks (also referred to as navigation task(s)) may be completed through interactions with the UI elements, thus realizing functions required by the user 101. Such navigation tasks can include but are not limited to login, password modification, account registration, keyword search, cookie setting, adding to shopping cart, pop-up window removal, etc.

In the example in FIG. 1, a current UI 110 as presented includes one or more UI elements, which are also called current elements. As shown in FIG. 1, the current UI 110 includes current elements 115-1, 115-2, 115-3, 115-4 and 115-5, which are also called the current element(s) 115 individually or collectively.

It is to be understood that the environment 110 shown in FIG. 1 is only an example and does not imply any limitation on the scope of the present disclosure. The current UI and the number and type of the UI elements shown in FIG. 1 are schematic and are not intended to limit the scope of this disclosure. In the implementation of the present disclosure, the UI processed can be any appropriate type of UI, which may include any appropriate number and type of UI elements. In addition, although the text in the UI 110 is shown in English, it is only an example and is not intended to limit the scope of the present disclosure. In the implementation of the present disclosure, the UI processed may be provided in any suitable language or languages.

Correctly identifying, understanding the UI and effectively navigating the UI may help or complete the navigation task on behalf of the users, thereby accurately and efficiently implement the functions required by the users. Therefore, it is expected to effectively navigate the UI and further implement the UI automated navigation.

Some solutions provide UI navigation for a web navigation task. However, these solutions mainly involve the web navigation task in simulated website environments. Web pages included in the simulated website environments are usually much simpler than those in the real world. In addition, a predefined navigation task in these simulated website environments is usually very simple and relates to special instructions, such as clicking the button below the text box. Therefore these simulated navigation tasks are much simpler than those in the real world.

Among these solutions, the solution based on reinforcement learning needs large-scale training data and a reward function. However, for a real-world navigation task, it is difficult to design a reward function that can give accurate feedback, and it is expensive to collect a large amount of data. The solution of multi-task learning makes use of the knowledge shared among a plurality of related navigation tasks. In this solution, different navigation tasks are associated with different simulation environments, respectively. However, in a real-world website, different navigation tasks may be performed on the same web page. This makes it difficult to apply this solution on a real-world web page. In addition to web pages, other types of UIs also have similar problems.

The example implementation of the present disclosure provides a solution for UI automated navigation. According to various implementations of the present disclosure, in response to the current UI being presented, tokens (that is, quantitative representations of the UI elements) representing the UI elements are generated for the UI elements. These UI elements include at least one or more elements in the current UI. The generated tokens are transformed into respective feature representations at least using the information specific to the current navigation task. Based on these feature representations, a target element is determined from the UI elements of the current UI. Then, an operation associated with the target element is performed, such as clicking the target element, entering text(s) in an area of the target element, and so on.

In the implementation of the present disclosure, the quantitative representation of the UI element is transformed into the feature of the UI element using information specific to the navigation task, thereby the information specific to the navigation task is reflected in the feature of the UI element. It helps to improve the effectiveness and accuracy for each navigation task, and the task-specific information can be specific to the navigation task in the real world, which makes the implementation of the present disclosure can effectively process the UI in the real world. On the other hand, the plurality of navigation tasks can be processed automatically by using information specific to different navigation tasks. This leads to wide applicability for the implementation of the present disclosure.

Some example implementations of the present disclosure will be described in more detail below with reference to the drawings.

### Example Page Navigation Architecture

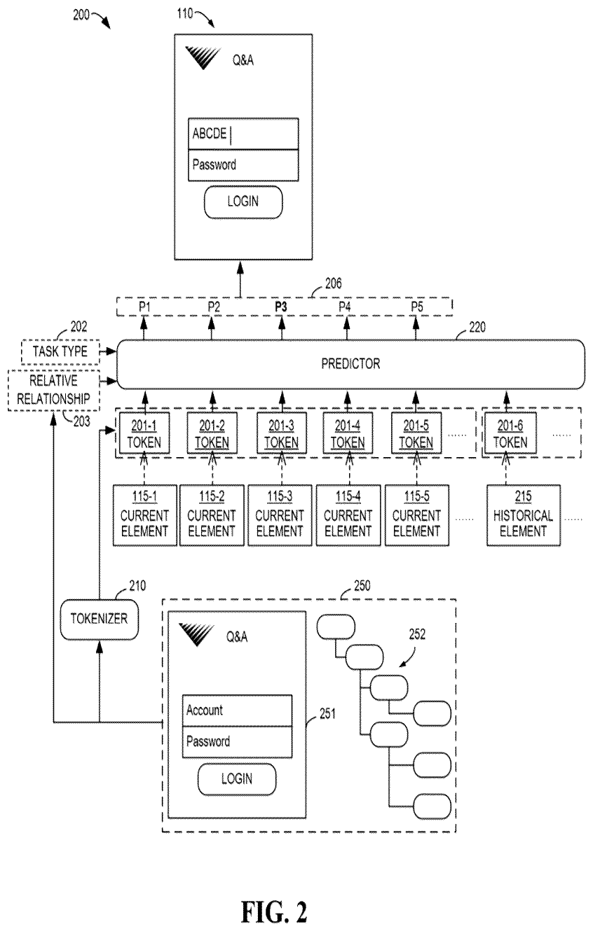

FIG. 2 shows an example architecture 200 for UI automated navigation according to some implementations of the present disclosure. An example operation of the architecture 200 is described below with reference to FIG. 1. A tokenizer 210 is used to generate tokens representing the UI elements, which token can be a quantitative representation of the UI element. Specifically, for a set of UI elements, the tokenizer 210 generates a set of tokens that represent the set of UI elements respectively. Each token corresponds to a UI element. This set of UI elements include at least the current elements in the current UI 110. In the example of FIG. 2, the tokens 201-1, 201-2, 201-3, 201-4 and 201-5 correspond to the current elements 115-1, 115-2, 115-3, 115-4 and 115-5 in the current UI 110, respectively.

In some implementations, the set of UI elements may further include a UI element that is used as a historical target element in a historical interaction (that is, a UI element that is interacted in a historical interaction), also known as a historical element. For example, the token 201-6 represents a historical element 215. In the following, the tokens 201-1, 201-2, 201-3, 201-4, 201-5 and 201-6 can be collectively referred to as a set of tokens 201 or individually as a token 201.

The historical element may include respective target elements involved in an interaction trajectory started from the first UI. Further, in some implementations, if the interaction trajectory is relatively long, then historical target element(s) in a historical interaction whose distance from the current UI is less than a threshold distance may be considered, while historical interaction(s) whose distance is greater than the threshold may not be considered. This is because the historical interaction which is too far away from the current UI may possibly have no association with the navigation task of the current UI. As an example, the distance between the current UI and the historical interaction may be measured by the number of interactions since an occurrence of a corresponding historical interaction.

Navigation tasks such as password modification, account registration, and adding to shopping cart actually involve a series of interactions. By considering the historical target element of the interaction trajectory, it is helpful to predict the target element for the current navigation task more accurately. In this way, the performance of completing this kind of continuous navigation task can be improved.

In order to generate the token 201 representing the UI element, UI information 250 may be provided to the tokenizer 210. The UI information 250 may include an image 251 of the UI, such as a screenshot, which provides visual information. The UI information 250 may further include metadata 252 of the UI, such as a hierarchy representing relationships between UI elements. In the case that the UI is a web page, the metadata 252 may include a document object model (DOM). In the case that the UI is an APP page, the metadata 252 may include a view level (VH). It is to be understood that the image 251 and the metadata 252 are only examples of UI information and are not intended to limit the scope of the present disclosure. In the implementation of the present disclosure, the tokenizer 210 may utilize any suitable type of UI information.

The tokenizer 210 may extract element information of the UI element from the UI information 250 to describe one or more aspects of the UI element.

In some implementations, the extracted element information may include the type of the UI element. The type may include but is not limited to “input”, “clickable element”, “plain text” and “icon”. The type of the UI element may be determined based on the UI metadata. In one example, if the label name of a UI element in the metadata (such as DOM) is “input”, then the type of the UI element is “input”. If the label name of a UI element in the metadata is “button”, then the type of the UI element is “clickable element”. If the text of a UI element is not empty, then the type of the UI element is “plain text”. If the text of a UI element is empty, then the type of the UI element is “icon”. For the current UI 110 in the example of FIG. 1, the type of the current element 115-1 is “icon”, the type of the current element 115-2 is “plain text”, the type of the current elements 115-3 and 115-4 is “input”, and the type of the current element 115-5 is “clickable element”. The types of the UI elements and their classification described here are only examples and are not intended to limit the scope of this disclosure. In the implementation of the present disclosure, the UI elements can be classified in any suitable way.

Alternatively or in addition to, in some implementations, the extracted element information may include a text description of the UI element. The UI metadata may include a plurality of items for the UI element. These items can be concatenated into a string as a text description of the UI element. For UI elements that do not have meaningful items in the metadata (such as elements with the type “icon”), a classifier may be used to classify the UI element. The label of the classified category may be used as a text description of the UI element.

Alternatively or in addition to, in some implementations, the extracted element information may include a position of the UI element in a UI in which it is located. For the current element 115, the position is a position of the current element 115 in the current UI 110. For the historical element 215, the position is a position of the historical element 215 in a UI with which the historical element 215 is interacted. This kind of position may be represented by a two-dimensional position of the UI element in the image 251.

Alternatively or in addition to, in some implementations, the extracted element information may include the occurrence time of the UI element relative to the current UI 110, which is also called temporal location. The temporal location may be measured by a distance between the current UI 110 and the historical interaction as described above. For example, the temporal location of the current element 115 can be 0 because the current element 115 is in the current UI 110. The temporal location of a historical element that acts as the target element in the last interaction may be 1, and so on. Using the temporal location, the current element may be explicitly distinguished from the historical element and different historical elements may be distinguished.

In the implementation described above, the element information of the UI element is extracted from the UI information 250 by the tokenizer 210. Alternatively, in some implementations, the element information described above may be extracted by other modules and provided to the tokenizer 210.

The tokenizer 210 then generates a token based on the element information of the UI element. For example, for a UI element, one or more aspects of its element information (such as the above mentioned type, text, position, etc.) may be quantified, and the quantified element information may be concatenated as a token. The generated token 201 is fed to a predictor 220.

In addition to the token 201, inputs of the predictor 220 further include a task type 202 of the current navigation task. The types of the navigation tasks may include but are not limited to login, password modification, account registration, keyword search, cookie setting, adding to shopping cart, pop-up window removal, etc. It is to be understood that the types of these navigation tasks are only examples and are not intended to limit the scope of the present disclosure. In the implementation of the present disclosure, any suitable type of the navigation task may be processed.

In some implementations, the current navigation task may be specified by the user 101. For example, options may be presented for a plurality of predetermined navigation tasks through the user device 102. The user 101 may select a navigation task from these predetermined navigation tasks. Furthermore, the current navigation task may be determined based on the user selection. In the case where the predictor 220 is implemented with a machine learning model, the predictor 220 has been trained using data related to these predetermined navigation tasks.

Alternatively, in some implementations, the current navigation task may be determined in other ways. For example, the current navigation task may be predicted by another module. The implementation of the present disclosure is not limited in this regard.

In some implementations, inputs of the predictor 220 may further include a relative relationship 203 between the UI elements. The relative relationship 203 may include a relative relationship between different current elements 115, a relative relationship between the current elements 115 and the historical element 205, and a relative relationship between different historical elements.

The relative relationship between two UI elements may include a relative encoded position of the two UI elements obtained from the UI metadata. Take a web page as an example, a relative form ID in the DOM may be used to represent the relative encoded position. If the form ID of a UI element is 0, it means that the UI element is not in any form. For any two UI elements, the value of the relative encoded position may be determined based on whether the form IDs of the two elements are 0 and whether the two elements are in the same UI. It is to be understood that the form ID described herein is only an example and is not intended to limit the scope of the present disclosure. Depending on the type of the UI metadata, any appropriate type of relative encoded position may be used.

Alternatively or in addition to, the relative relationship between two UI elements may include a relative spatial position of the two UI elements. If the two UI elements (such as two current elements 115) are in the same UI, then the relative spatial position of the two UI elements can be expressed by their relative distance in the UI. If the two UI elements are located in different UIs, the relative spatial position can be represented by a predetermined value.

In this implementation, the relative relationship 203 explicitly represents the relationship between any two UI elements. This is helpful for the predictor 220 to locate the current target element from the UI elements.

The predictor 220 predicts the target element in the current element 115 for the current navigation task based on the token 201, the task type 202, and the optional relative relationship 203. Specifically, based on the task type 202, the predictor 220 determines specific information corresponding to the current navigation task. The specific information may indicate the transformation to be performed on the token 201 for the current navigation task, which is used to convert the token into a feature representation. This kind of information used in the transformation is specific to the current navigation task, but not shared among different navigation tasks. The predictor 220 may have specific information corresponding to the plurality of predetermined navigation tasks. Based on the task type 202, the predictor 220 may select specific information corresponding to the current navigation task. Then, the predictor 220 uses this kind of specific information to transform the token 201 into the feature representation of the UI element. It is to be understood that the feature representation obtained in this way can reflect features that are more relevant to the current navigation task.

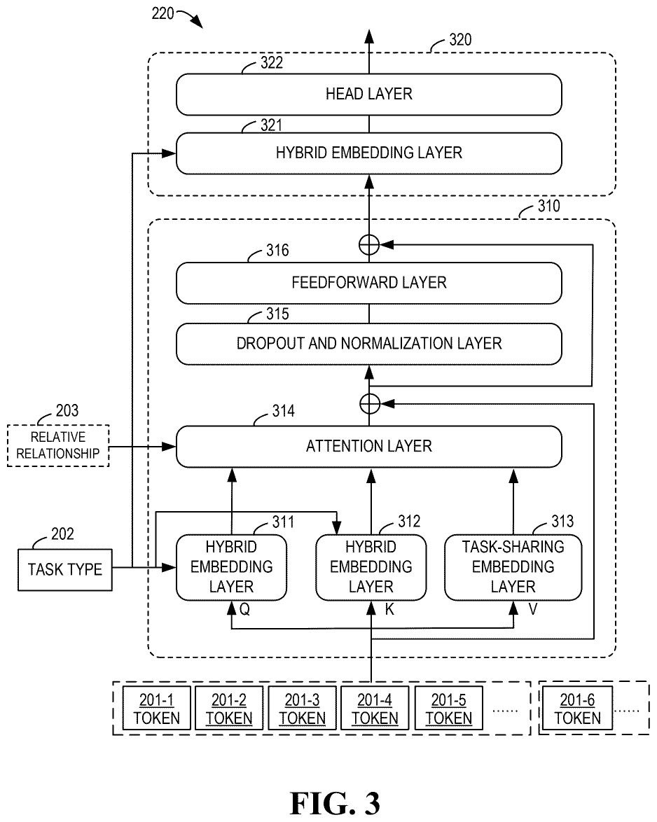

In some implementations, in order to transform the token 201 into the feature representation of the UI element, the predictor 220 may also use the shared information for the plurality of navigation tasks. The shared information may indicate a common transformation for the navigation tasks to be performed on the token 201. This kind of shared information may reflect the common knowledge between different navigation tasks, which helps to further improve the performance of the UI navigation. The shared information may include one or more shared information items. Similarly, the specific information may include one or more specific information items. With reference to FIG. 3, the following paragraph will provide an example of transforming tokens into feature representations according to a combination of the shared information and the specific information.

Based on the respective feature representations of the UI elements, the predictor 220 obtains a prediction result 206. The prediction result 206 may include a probability that the current element 115 acts as the target element. The current element with the highest probability may be determined as the target element for the current navigation task. In the example in FIGS. 2, P1, P2, P3, P4 and P5 in the prediction result 206 are the probabilities that the current elements 115-1, 115-2, 115-3, 115-4 and 115-5 are target elements respectively. P3 is assumed to be the greatest value. Accordingly, the current element 115-3 is determined as the target element. Alternatively or in addition to, the prediction result 206 may include a probability that the current element 115 is not the target element.

The operation associated with the target element is performed in response to the determination of the target element. The performed operation is relevant to the type of the target element. For example, if the type of the target element is “clickable element”, the performed operation is clicking the target element. In another example, if the type of the target element is “input”, the performed operation is inputting the predetermined content. In the example of FIG. 2, the account name “ABCDE” is inputted in the area of the current element 115-3.

Any suitable algorithm may be used to implement the predictor 220. In some implementations, a machine learning model may be used to implement the predictor 220. In this implementation, the specific information and optional shared information as mentioned above may be implemented as model parameters. Each specific information item may be implemented as parameters of different modules of the model. Similarly, the shared information items may be implemented as parameters of different modules of the model. An example of this will be described below.

The example architecture 200 for UI automated navigation is described above with reference to FIG. 2. It is to be understood that the UI, the UI elements, the UI information, and the predicted target element, etc. shown in FIG. 2 are only examples and are not intended to limit the scope of this disclosure. In addition, it is to be understood that the target element determined for the current UI 110 may be used as a historical element for the subsequent UI.

### Example Predictor

As described with reference to FIG. 2, in some implementations, a machine learning model may be used to implement the predictor 220. An example of the predictor 220 will be described below with reference to FIG. 3. As shown in FIG. 3, the predictor 220 generally includes a feature extraction module 310 and an output module 320. In the feature extraction module 310, a set of tokens 201 are transformed into at least one set of transformed tokens by using the specific information corresponding to the current navigation task and the shared information for the plurality of predetermined navigation tasks. Each token 201 is transformed using the shared information and the specific information. Then, based on the transformed tokens, the respective feature representations of the UI elements (including the current element and the optional historical element) may be generated. In the output module 320, the target element is predicted for the current navigation task based on the respective feature representations of the UI elements.

The predictor 220 may be implemented using any suitable network structure. In the example of FIG. 3, a transformer is used to implement the predictor 220. Each token 201 is fed to a hybrid embedding layer 311, a hybrid embedding layer 312 and a task-sharing embedding layer 313 to generate a transformed token as a query (Q), a transformed token as a key (K) and a transformed token as a value (V), respectively. The hybrid embedding layer 311 and the hybrid embedding layer 312 need to use parameters specific to the current task. Therefore, the task type 202 is fed to the hybrid embedding layer 311 and the hybrid embedding layer 312.

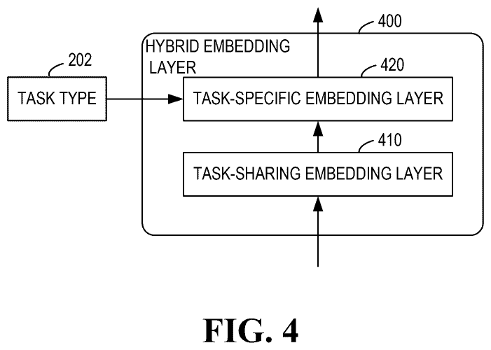

A hybrid embedding layer 400 shown in FIG. 4 may be regarded as an example implementation of the hybrid embedding layer 311 and the hybrid embedding layer 312 in FIG. 3. A task-sharing embedding layer 410 has shared parameters for the plurality of predetermined navigation tasks, and the shared parameters may be regarded as an example implementation of shared information items. Using the shared parameters, the tokens input to the hybrid embedding layer 400 are transformed into intermediate tokens. For example, the task-sharing embedding layer 410 may be implemented as a fully connected (FC) layer. Parameters of the fully connected layer are shared by the plurality of predetermined navigation tasks.

The intermediate token is then fed to a task-specific embedding layer 420. The task-specific embedding layer 420 may have specific parameters of the plurality of predetermined navigation tasks, and such specific parameters may be regarded as example implementations of specific information items. Based on the task type 202, the task-specific embedding layer 420 applies the specific parameters corresponding to the current navigation task to the intermediate token, so as to generate the transformed token. That is, the task-specific embedding layer 420 performs task-adaptive embedding. For example, the task-specific embedding layer 420 may be implemented as a dynamic fully connected layer. Parameters of the dynamic fully connected layer vary dynamically depending on the task type 202.

Through the task-sharing embedding layer, the information shared between different tasks is encoded; through the task-specific embedding layer, the information specific to the current task is encoded. In this way, the learning of task-sharing knowledge and task-specific knowledge may be decoupled, thereby allowing the plurality of navigation tasks to be processed under a common framework. It is to be understood that the structure of the hybrid embedding layer shown in FIG. 4 is only an example. The hybrid embedding layer may also have other structures. For example, the task-specific embedding layer may be located before the task-sharing embedding layer. In another example, the hybrid embedding layer may include the plurality of task-specific embedding layers and/or the plurality of task-sharing embedding layers.

Returning to FIG. 3, the hybrid embedding layer 311 transforms each token 201. The generated first set of transformed tokens are fed to an attention layer 314 as the query. The hybrid embedding layer 312 transforms each token 201. The generated second set of transformed tokens are fed to the attention layer 314 as the key. The task-sharing embedding layer 313 is similar to the task-sharing embedding layer 410, that is, the task-sharing embedding layer 313 has the shared parameters for the plurality of predetermined navigation tasks. The third set of transformed tokens generated by the task-sharing embedding layer 313 are fed to the attention layer 314 as the value.

The attention layer 314 determines attention information based on the first set of transformed tokens, the second set of transformed tokens, and the optional relative relationship 203. The attention information indicates the correlation between any two UI elements, such as the correlation between any two current elements 115, the correlation between the current element and the historical element, and the correlation between two historical elements. The attention information may be an attention weight matrix, for example. The attention layer 314 then weights the third set of transformed tokens based on the attention information. The weighted transformed tokens generate the respective feature representations of the UI elements through a dropout and normalization layer 315 and a feedforward layer 316, etc.

Although one feature extraction module 310 is shown in FIG. 3, this is only an example. In some implementations, the predictor 220 may include a feature extraction module with multiple cascades with the same structure.

The feature representation of the UI element is fed to the output module 320, which predicts the target element based on the feature representation. As shown in FIG. 3, in some implementations, the output module 320 may include a hybrid embedding layer 321. The hybrid embedding layer 321 may have a structure similar to that of the hybrid embedding layer 400. That is, the task-sharing embedding layer in the hybrid embedding layer 321 has the shared parameters for the plurality of predetermined navigation tasks, and the task-specific embedding layer has respective specific parameters for the plurality of predetermined navigation tasks. Based on the task type 202, the hybrid embedding layer 321 applies specific parameters corresponding to the current navigation task. Accordingly, in the hybrid embedding layer 321, the shared parameters and specific parameters are used to transform the feature representation of the UI element. A head layer 322 determines a probability that each UI element acts as a target element and/or a probability that each UI element does not act as a target element based on the transformed feature representation. For example, the head layer 322 may be implemented as a linear layer.

An example operation of the predictor 220 is described above with reference to FIG. 3. For any given token x∈ [symbol] , the transformed token obtained by the hybrid embedding layers (for example, the hybrid embedding layers 311 and 312) may be expressed as:

\hat{x}=xWₛₕWₛₚ(T) (1)

Where x represents the token input to the hybrid embedding layer, \hat{x} represents the transformed token output by the hybrid embedding layer, and T∈ [symbol] represents a one-hot vector of the task type from N predetermined navigation tasks.

Wₛₕ∈ [symbol] represents the task-sharing embedding layer, which may be implemented by a trainable fully connected layer and performs the same transformation for different navigation tasks. Wₛₚ∈ [symbol] represents the task-specific embedding layer, which may be implemented as:

Wₛₚ(T)=Reshape(WT) (2)

Where W∈ [symbol] is a learnable matrix, Reshape(⋅) is an operation for changing the dimension of WT from C²×1 to C×C. The task-specific embedding layer implements an embedding function based on the type of the navigation task, which may be understood as a task adaptive modulation according to the embedding results of task sharing by using the dynamic FC layer.

By applying the hybrid embedding layers to the tokens used as the query and the key, the adaptive attention mechanism may be implemented for navigation tasks. The attention scores of the j^{th} UI element and the i^{th} UI element may be expressed as below:

$${e}_{i , j} ( T ) = \frac{( {x}_{i} {W}_{sh}^{Q} {W}_{sp}^{Q} ( T ) + {r}_{i , j}^{Q} ) {( {x}_{j} {W}_{sh}^{K} {W}_{sp}^{K} ( T ) + {r}_{i , j}^{K} )}^{T}}{\sqrt{{d}_{z}}} \qquad ( 3 )$$

Where i and j range from 1 to n, and n is the total number of the token(s) 201.

$${r}_{i , j}^{K} and {r}_{i , j}^{Q}$$

represent the relative relationship 203 described with reference to FIG. 2, which may include at least one of the relative encoded position and the relative spatial position. d_{z} represents the vector dimension of the token 201.

A softmax function is used to convert the attention score to determine the attention weight. Accordingly, the attention weight α_{i,j}(T) for the j^{th} UI element relative to the i^{th} UI element may be computed by the formula as below:

$${α}_{i , j} ( T ) = \frac{exp ( {e}_{i , j} ( T ) )}{{\sum }_{k = 1}^{n} exp ( {e}_{i , k} ( T ) )} \qquad ( 4 )$$

Accordingly, a feature of the i^{th} UI element output by the attention layer 314 is expressed as below:

$${𝓏}_{i} ( T ) = {\sum }_{j = 1}^{n} {α}_{i , j} ( T ) ( {x}_{j} {W}^{V} ) \qquad ( 5 )$$

Where W^{V} represents the task-sharing embedding layer 313.

Through the operations represented by the above formulas, the feature representation of the UI element may be obtained through a cascaded transformer block. The hybrid embedding layer 321 in the output module 320 applies to the feature representation an operation similar to Formula (2). The head layer 322 may be implemented as a linear layer, which transforms each feature vector of with d_{z} dimensions into one dimension (corresponding to the probability of being the target element) or two dimensions (corresponding to the probability of being the target element and the probability of not being the target element, respectively).

In the implementation described above with reference to FIG. 3, the shared information is implemented as parameters of the task-sharing embedding layer, while the specific information is implemented as parameters of the task-specific embedding layer. In this implementation, the hybrid embedding layer is applied to tokens used as the query and the key, and the task-sharing embedding layer is applied to tokens used as the value. Accordingly, in the attention mechanism, the tokens used as the value reflect the unknowable features of the tasks, while the tokens used as the query and the key reflect the features conditional on the tasks. The predictor implemented in this way may use multi-task data in training and may be benefited from strategy learning promoted by different tasks.

In the training of the predictor shown in FIG. 3, a series of “successful” human-computer interaction trajectories may be used as the training data and supervision information. The human selected UI element may be used as the ground truth to supervise the training of the predictor 220.

Such predictor 220 is universal because it integrates strategy learning of the plurality of navigation tasks. By learning common representations between different tasks within the joint framework, the predictor 220 may make full use of the collected data. Therefore, the predictor 220 also has high sample efficiency. In addition, in the training, only “successful” human-computer interaction data is needed, thereby avoiding requirements for collecting various interaction trajectories and designing complex reward functions.

It is to be understood that the structure of the predictor 220 described with reference to FIG. 3 is an example. In the implementation of the present disclosure, it is not limited to arranging the hybrid embedding layer, the task-sharing embedding layer, the task-specific embedding layer, etc. in the way shown in FIG. 3. For example, in some implementations, the task-specific embedding layers may be used for the query, the key, and the value. For another example, in some implementations, the hybrid embedding layers may be used for the query, the key, and the value. In another example, in some implementations, the task-specific embedding layer mays be used for the query and the key, and the task-sharing embedding layer may be used for the value.

In addition, although the transformer is used to implement the predictor 220 in the example of FIG. 3, this is only an example. In other implementations, the predictor 220 may be implemented with any machine learning model that is known or to developed in the future.

### Example Flow

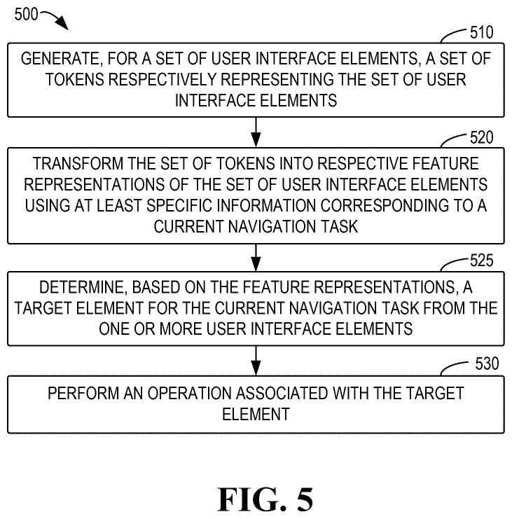

FIG. 5 shows a flowchart of a process 500 for UI automated navigation according to some implementations of the present disclosure. The process 500 may be implemented at the user device 110 in FIG. 1 or at another computing device, such as a device providing UI navigation services.

At a block 510, a set of tokens respectively representing a set of UI elements are generated for the set of UI elements. The set of UI elements includes at least one or more UI elements in a current user interface being presented.

In some implementations, the set of UI elements may further include a UI element that acts as a historical target element in a historical interaction.

In some implementations, generating the set of tokens comprises: generating a token representing a given user interface element of the set of user interface elements based on at least one of the following of the given user interface element: a type of the given user interface element, a text description of the given user interface element, a position of the given user interface element in a user interface in which the given user interface element is located, or an occurrence time of the given user interface element relative to the current user interface.

At a block 520, the set of tokens is transformed into respective feature representations of the set of UI elements using at least specific information corresponding to a current navigation task. At a block 525, based on the feature representations, a target element is determined for the current navigation task from the one or more UI elements. As an example, the current navigation task may include but is not limited to login, password modification, account registration, keyword search, cookie setting, adding to shopping cart, pop-up window removal, etc.

In some implementations, the current navigation task may be specified by the user. The options for the plurality of predetermined navigation tasks may be presented. The plurality of predetermined navigation tasks include the current navigation task. User selections may be received for a navigation task in the plurality of predetermined navigation tasks. The current navigation task may be determined based on the user selection. For example, the navigation task selected by the user is the current navigation task.

In some implementations, the set of tokens may be transformed into at least one set of transformed tokens using the shared information for a plurality of predetermined navigation tasks and the specific information. The plurality of predetermined navigation tasks include the current navigation task. The shared information and the specific information may be implemented as parameters of any machine-executable algorithm (such as a machine learning model). In some implementations, the set of tokens may be transformed into a set of intermediate tokens using a first shared information item (for example, a parameter of the task-sharing embedding layer 410) in the shared information. The set of intermediate tokens may be transformed into a set of transformed tokens of the at least one set of transformed tokens using a first specific information item (for example, a parameter of the task-specific embedding layer 420) corresponding to the current navigation task in the specific information. For example, the first set of transformed tokens used as queries may be generated by the hybrid embedding layer 311. In another example, the second set of transformed tokens used as keys may be generated by the hybrid embedding layer 312.

The respective feature representations of the set of UI elements may be determined based on the at least one set of transformed tokens. In some implementations, the at least one set of transformed tokens include a first set of transformed tokens and a second set of transformed tokens corresponding to the set of user interface elements. For example, the first and second sets of transformed tokens may be generated by the hybrid embedding layers 311 and 312, respectively. A relative relationship between a first user interface element and a second user interface element of the set of user interface elements may be obtained. Attention information may be determined based on the first set of transformed tokens, the second set of transformed tokens and the relative relationship. The attention information indicates correlation between the first user interface element and the second user interface element. The set of tokens may be transformed into a third set of transformed tokens corresponding to the set of user interface elements using a second shared information item (for example, a parameter of the task-sharing embedding layer 313) in the shared information. For example, a third set of transformed tokens as values may be generated through the task-sharing embedding layer 313. The feature representations may be determined by weighting the third set of transformed tokens based on the attention information.

In some implementations, the relative relationship between the first UI element and the second UI element may include a relative encoded position of the first UI element and the second UI element obtained from metadata of the user interface, such as the relative form ID. Alternatively or in addition to, the relative relationship between the first UI element and the second UI element may include a relative spatial position of the first UI element and the UI element.

Furthermore, the target element may be determined based on feature representations. In some implementations, the feature representations may be transformed using a third shared information item in the shared information (for example, a task shared embedding layer parameter in the hybrid embedding layer 321) and a third specific information item in the specific information corresponding to the current navigation task (for example, a task-specific embedding layer parameter in the hybrid embedding layer 321). The probability of one or more UI elements being the target element(s) may be determined based on the transformed feature representation.

At block 530, an operation associated with the target element is performed. For example, depending on the type of the target element, the target element may be clicked, or a predefined content may be entered in an area of the target element.

### Sample Device

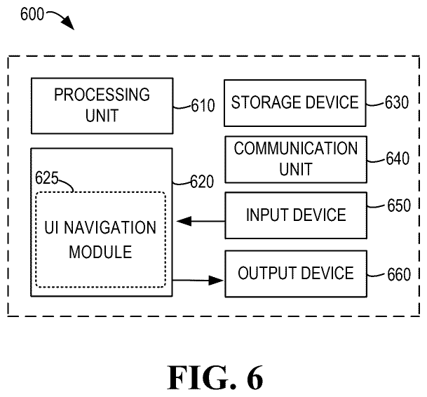

FIG. 6 shows a schematic block diagram of an electronic device capable of implementing various implementations of the present disclosure. It is to be understood that the electronic device 600 shown in FIG. 6 is only an example and should not constitute any limitation on the function and scope of the implementation described in the present disclosure. As shown in FIG. 6, the electronic device 600 comprises an electronic device 600 in a form of a general-purpose computing device. Components of the electronic device 600 may comprise, but are not limited to, one or more processors or processing units 610, a memory 620, a storage device 630, one or more communication units 640, one or more input devices 650, and one or more output devices 660.

In some implementations, the electronic device 600 can be implemented as a computing device, a computing system, a server, mainframe, and other computing capable devices.

The processing unit 610 can be an actual or a virtual processor and can perform various processes according to the programs stored in the memory 620. In a multiprocessor system, a plurality of processing units execute computer executable instructions in parallel to improve the parallel processing capability of electronic device 600. The processing unit 610 may comprise a central processing unit (CPU), a graphics processing unit (GPU), a microprocessor, a controller, and/or a microcontroller.

The electronic device 600 typically comprises a plurality of computer storage media. Such media may be any available media accessible to the electronic device 600, comprising but not being limited to volatile and non-volatile media, removable and non-removable media. The memory 620 may comprise a volatile memory (such as a register, a cache, a random access memory (RAM)), a non-volatile memory (such as a read-only memory (ROM), an electrically erasable programmable read-only memory (EEPROM), a flash memory), or some combination thereof. The storage device 630 may comprise removable or non-removable media, and may comprise computer-readable media such as memories, flash drives, disks, or any other media that can be used to store information and/or data and can be accessed within the electronic device 600.

The electronic device 600 may further comprise additional removable/non removable, volatile/non-volatile storage media. Although not shown in FIG. 6, a disk drive for reading or writing from a removable, a nonvolatile disk and an optical disk drive for reading or writing from a removable, a nonvolatile optical disk may be provided. In these cases, each drive may be connected to a bus (not shown) by one or more data medium interfaces.

The communication unit 640 realizes communication with another computing device through a communication medium. Additionally, the functions of the components of the electronic device 600 can be implemented in a single computing cluster or a plurality of computing machines that can communicate through a communication connection. Therefore, electronic device 600 can operate in a networked environment using a logical connection to one or more other servers, personal computers (PCs), or another general network node.

The input device 650 may be one or more various input devices, such as a mouse, a keyboard, a data import device, and the like. The output device 660 may be one or more output devices, such as a display, a data export device, and the like. The electronic device 600 can also communicate with one or more external devices (not shown) through the communication unit 640 as required, such as storage devices, display devices, etc., with one or more devices that enable users to interact with the electronic device 600, or with any device (such as network cards, modems, etc.) that enables the electronic device 600 to communicate with one or more other computing devices. Such communication may be performed via an input/output (I/O) interface (not shown).

In some implementations, in addition to being integrated on a single device, some or all the components of the electronic device 600 may also be set in the form of a cloud computing architecture. In the cloud computing architecture, these components can be remotely arranged and can work together to implement the functions described in the present disclosure. In some implementations, cloud computing provides computing, software, data access and storage services, which do not require the end user to know the physical location or configuration of the system or hardware providing these services. In various implementations, cloud computing uses appropriate protocols to provide services over a wide area network, such as the internet. For example, cloud computing providers provide applications over a wide area network, and they can be accessed through a web browser or any other computing component. The software or component of cloud computing architecture and corresponding data can be stored on the server at a remote location. Computing resources in a cloud computing environment can be combined at remote data center locations or they can be dispersed. Cloud computing infrastructure can provide services through shared data centers, even if they represent a single point of access for users. Therefore, the components and functions described herein can be provided from a service provider at a remote location using a cloud computing architecture. Alternatively, they may be provided from a conventional server, or they may be installed directly or otherwise on a client device.

The electronic device 600 may be used to implement hierarchical relationship parsing in various implementations of the present disclosure. The memory 620 may comprise one or more modules having one or more program instructions, which may be accessed and run by the processing unit 610 to implement various implemented functions described herein. For example, the memory 620 may comprise a hierarchical relationship parsing module 625 for determining the structure of a table in an image. As shown in FIG. 6, the electronic device 600 can acquire the input required for UI navigation through the input device 650 and can provide the output of UI navigation through the output device 660. In some implementations, the electronic device 600 may also receive input from other devices (not shown) via the communication unit 640.

### Example Implementations

Some example implementations of the present disclosure are listed below.

In one aspect, the present disclosure provides a computer implementation method. The method comprises: generating, for a set of user interface elements, a set of tokens respectively representing the set of user interface elements, the set of user interface elements at least including one or more user interface elements in a current user interface being presented; transforming the set of tokens into respective feature representations of the set of user interface elements using at least specific information corresponding to a current navigation task; determining, based on the feature representations, a target element for the current navigation task from the one or more user interface elements; and performing an operation associated with the target element.

In some example implementations, the set of user interface elements further includes a user interface element that acts as a historical target element in a historical interaction.

In some example implementations, transforming the set of tokens into the respective feature representations comprises: transforming the set of tokens into at least one set of transformed tokens using shared information for a plurality of predetermined navigation tasks and the specific information, the plurality of predetermined navigation tasks including the current navigation task; and determining the respective feature representations of the set of user interface elements based on the at least one set of transformed tokens.

In some example implementations, transforming the set of tokens into the at least one set of transformed tokens comprises: transforming the set of tokens into a set of intermediate tokens using a first shared information item in the shared information; and transforming the set of intermediate tokens into a set of transformed tokens of the at least one set of transformed tokens using a first specific information item corresponding to the current navigation task in the specific information.

In some example implementations, the at least one set of transformed tokens includes a first set of transformed tokens and a second set of transformed tokens corresponding to the set of user interface elements, and determining the respective feature representations of the set of user interface elements comprises: obtaining a relative relationship between a first user interface element and a second user interface element of the set of user interface elements; determining attention information based on the first set of transformed tokens, the second set of transformed tokens and the relative relationship, the attention information indicating correlation between the first user interface element and the second user interface element; transforming the set of tokens into a third set of transformed tokens corresponding to the set of user interface elements using a second shared information item in the shared information; and determining the feature representations by weighting the third set of transformed tokens based on the attention information.

In some example implementations, the relative relationship includes at least one of: a relative encoded position of the first user interface element and the second user interface element obtained from metadata of a user interface, or a relative spatial position of the first user interface element and the second user interface element.

In some example implementations, determining the target element comprises: transforming the feature representations using a third shared information item in the shared information and a third specific information item corresponding to the current navigation task in the specific information; and determining, based on the transformed feature representations, probabilities of the one or more user interface elements being the target element.

In some example implementations, generating the set of tokens comprises: generating a token representing a given user interface element of the set of user interface elements based on at least one of the following of the given user interface element: a type of the given user interface element, a text description of the given user interface element, a position of the given user interface element in a user interface in which the given user interface element is located, or an occurrence time of the given user interface element relative to the current user interface.

In some example implementations, the method further comprises presenting options for a plurality of predetermined navigation tasks including the current navigation task; receiving a user selection of a navigation task among the plurality of predetermined navigation tasks; and determining the current navigation task based on the user selection.

In another aspect, the present disclosure provides an electronic device. The electronic device comprises: a processor; and a memory coupled to the processor and comprising instructions stored thereon, the instructions when executed by the processor causing the electronic device to perform acts comprises: generating, for a set of user interface elements, a set of tokens respectively representing the set of user interface elements, the set of user interface elements at least including one or more user interface elements in a current user interface being presented; transforming the set of tokens into respective feature representations of the set of user interface elements using at least specific information corresponding to a current navigation task; determining, based on the feature representations, a target element for the current navigation task from the one or more user interface elements; and performing an operation associated with the target element.

In some example implementations, the set of user interface elements further includes a user interface element that acts as a historical target element in a historical interaction.

In some example implementations, transforming the set of tokens into the respective feature representations comprises: transforming the set of tokens into at least one set of transformed tokens using shared information for a plurality of predetermined navigation tasks and the specific information, the plurality of predetermined navigation tasks including the current navigation task; and determining the respective feature representations of the set of user interface elements based on the at least one set of transformed tokens.

In some example implementations, transforming the set of tokens into the at least one set of transformed tokens comprises: transforming the set of tokens into a set of intermediate tokens using a first shared information item in the shared information; and transforming the set of intermediate tokens into a set of transformed tokens of the at least one set of transformed tokens using a first specific information item corresponding to the current navigation task in the specific information.

In some example implementations, the at least one set of transformed tokens includes a first set of transformed tokens and a second set of transformed tokens corresponding to the set of user interface elements, and determining the respective feature representations of the set of user interface elements comprises: obtaining a relative relationship between a first user interface element and a second user interface element of the set of user interface elements; determining attention information based on the first set of transformed tokens, the second set of transformed tokens and the relative relationship, the attention information indicating correlation between the first user interface element and the second user interface element; transforming the set of tokens into a third set of transformed tokens corresponding to the set of user interface elements using a second shared information item in the shared information; and determining the feature representations by weighting the third set of transformed tokens based on the attention information.

In some example implementations, the relative relationship includes at least one of: a relative encoded position of the first user interface element and the second user interface element obtained from metadata of a user interface, or a relative spatial position of the first user interface element and the second user interface element.

In some example implementations, determining the target element comprises: transforming the feature representations using a third shared information item in the shared information and a third specific information item corresponding to the current navigation task in the specific information; and determining, based on the transformed feature representations, probabilities of the one or more user interface elements being the target element.

In some example implementations, generating a token representing a given user interface element of the set of user interface elements based on at least one of the following of the given user interface element: a type of the given user interface element, a text description of the given user interface element, a position of the given user interface element in a user interface in which the given user interface element is located, or an occurrence time of the given user interface element relative to the current user interface.

In some example implementations, the acts further comprises: presenting options for a plurality of predetermined navigation tasks including the current navigation task; receiving a user selection of a navigation task among the plurality of predetermined navigation tasks; and determining the current navigation task based on the user selection.

In another aspect, the present disclosure provides a computer program product. The computer program product is tangibly stored in a computer storage medium and comprises computer executable instructions. When the computer executable instructions are executed by the device, the device performs the acts comprises: generating, for a set of user interface elements, a set of tokens respectively representing the set of user interface elements, the set of user interface elements at least including one or more user interface elements in a current user interface being presented; transforming the set of tokens into respective feature representations of the set of user interface elements using at least specific information corresponding to a current navigation task; determining, based on the feature representations, a target element for the current navigation task from the one or more user interface elements; and performing an operation associated with the target element.

In some example implementations, the set of user interface elements further includes a user interface element that acts as a historical target element in a historical interaction.

In some example implementations, transforming the set of tokens into the respective feature representations comprises: transforming the set of tokens into at least one set of transformed tokens using shared information for a plurality of predetermined navigation tasks and the specific information, the plurality of predetermined navigation tasks including the current navigation task; and determining the respective feature representations of the set of user interface elements based on the at least one set of transformed tokens.

In some example implementations, transforming the set of tokens into the at least one set of transformed tokens comprises: transforming the set of tokens into a set of intermediate tokens using a first shared information item in the shared information; and transforming the set of intermediate tokens into a set of transformed tokens of the at least one set of transformed tokens using a first specific information item corresponding to the current navigation task in the specific information.

In some example implementations, the at least one set of transformed tokens includes a first set of transformed tokens and a second set of transformed tokens corresponding to the set of user interface elements, and determining the respective feature representations of the set of user interface elements comprises: obtaining a relative relationship between a first user interface element and a second user interface element of the set of user interface elements; determining attention information based on the first set of transformed tokens, the second set of transformed tokens and the relative relationship, the attention information indicating correlation between the first user interface element and the second user interface element; transforming the set of tokens into a third set of transformed tokens corresponding to the set of user interface elements using a second shared information item in the shared information; and determining the feature representations by weighting the third set of transformed tokens based on the attention information.

In some example implementations, the relative relationship includes at least one of: a relative encoded position of the first user interface element and the second user interface element obtained from metadata of the user interface, or a relative spatial position of the first user interface element and the second user interface element.

In some example implementations, determining the target element comprises: transforming the feature representations using a third shared information item in the shared information and a third specific information item corresponding to the current navigation task in the specific information; and determining, based on the transformed feature representations, probabilities of the one or more user interface elements being the target element.

In some example implementations, generating the set of tokens comprises: generating a token representing a given user interface element of the set of user interface elements based on at least one of the following of the given user interface element: a type of the given user interface element, a text description of the given user interface element, a position of the given user interface element in a user interface in which the given user interface element is located, or an occurrence time of the given user interface element relative to the current user interface.

In some example implementations, the acts further comprises presenting options for a plurality of predetermined navigation tasks including the current navigation task; receiving a user selection of a navigation task among the plurality of predetermined navigation tasks; and determining the current navigation task based on the user selection.

In another aspect, the present disclosure provides a computer-readable medium on which computer executable instructions are stored, the instructions, when executed by a device, cause the device to execute one or more example implementations of the methods in the above aspects.

The functions described above herein may be performed at least partially by one or more hardware logical units. For example and without limitation, example types of hardware logic components that can be used include: a field programmable gate array (FPGA), an application specific integrated circuit (ASIC), an application specific standard product (ASSP), a system on chip (SOC), a load programmable logic device (CPLD), and so on.

The program code for implementing the methods of the present disclosure may be written in any combination of one or more programming languages. These program codes can be provided to a processor or controller of a general-purpose computer, a special purpose computer or another programmable data processing device, so that when the program code is executed by a processor or controller, the functions/operations specified in the flow chart and/or block diagram are implemented. The program code can be executed completely on the machine, partially on the machine, partially on the machine and partially on the remote machine or completely on the remote machine or server as a separate software package.

In the context of the present disclosure, a machine-readable medium may be a tangible medium, which may contain or store programs for use by or in combination with an instruction execution system, apparatus or device. The machine-readable medium may be a machine-readable signal medium or a machine-readable storage medium. Machine-readable media may include, but are not limited to, electronic, magnetic, optical, electromagnetic, infrared, or semiconductor systems, devices, or devices, or any suitable combination of the foregoing. A more specific example of a machine-readable storage medium would comprise an electrical connection based on one or more lines, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

In addition, although the operations are described in a particular order, it is to be understood that such operations are required to be performed in a particular order shown or in a sequential order, or that all illustrated operations should be performed to obtain a desired result. Under certain circumstances, multitasking and parallel processing may be beneficial. Similarly, although the above discussion contains a number of specific implementation details, these should not be interpreted as limiting the scope of the disclosure. Some characteristics described in the context of a separate implementation can also be implemented in a single implementation in combination. Conversely, various features described in the context of a single implementation can also be implemented in multiple implementations individually or in any suitable sub combination.

Although the subject matter has been described in terms specific to the structural features and/or method logic actions, it is to be understood that the subject matter defined in the appended claims is not necessarily limited to the specific features or actions described above. On the contrary, the specific features and actions described above are only examples of realizing the claims.

1-15. (canceled)

16. A computer implemented method, comprising:
generating, for a set of user interface elements, a set of tokens respectively representing the set of user interface elements, the set of user interface elements at least including one or more user interface elements in a current user interface being presented;
transforming the set of tokens into respective feature representations of the set of user interface elements using at least specific information corresponding to a current navigation task;
determining, based on the feature representations, a target element for the current navigation task from the one or more user interface elements; and
performing an operation associated with the target element.

17. The method of claim 16, wherein the set of user interface elements further includes a user interface element that acts as a historical target element in a historical interaction.

18. The method of claim 16, wherein transforming the set of tokens into the respective feature representations comprising:
transforming the set of tokens into at least one set of transformed tokens using shared information for a plurality of predetermined navigation tasks and the specific information, the plurality of predetermined navigation tasks including the current navigation task; and
determining the respective feature representations of the set of user interface elements based on the at least one set of transformed tokens.

19. The method of claim 18, wherein transforming the set of tokens into the at least one set of transformed tokens comprising:
transforming the set of tokens into a set of intermediate tokens using a first shared information item in the shared information; and
transforming the set of intermediate tokens into a set of transformed tokens of the at least one set of transformed tokens using a first specific information item corresponding to the current navigation task in the specific information.

20. The method of claim 18, wherein the at least one set of transformed tokens includes a first set of transformed tokens and a second set of transformed tokens corresponding to the set of user interface elements, and determining the respective feature representations of the set of user interface elements comprising:
obtaining a relative relationship between a first user interface element and a second user interface element of the set of user interface elements;
determining attention information based on the first set of transformed tokens, the second set of transformed tokens and the relative relationship, the attention information indicating correlation between the first user interface element and the second user interface element;
transforming the set of tokens into a third set of transformed tokens corresponding to the set of user interface elements using a second shared information item in the shared information; and
determining the feature representations by weighting the third set of transformed tokens based on the attention information.

21. The method of claim 20, wherein the relative relationship includes at least one of:
a relative encoded position of the first user interface element and the second user interface element obtained from metadata of a user interface, or
a relative spatial position of the first user interface element and the second user interface element.

22. The method of claim 18, wherein determining the target element comprising:
transforming the feature representations using a third shared information item in the shared information and a third specific information item corresponding to the current navigation task in the specific information; and
determining, based on the transformed feature representations, probabilities of the one or more user interface elements being the target element.

23. The method of claim 16, wherein generating the set of tokens comprises: generating a token representing a given user interface element of the set of user interface elements based on at least one of the following of the given user interface element:
a type of the given user interface element,
a text description of the given user interface element,
a position of the given user interface element in a user interface in which the given user interface element is located, or
an occurrence time of the given user interface element relative to the current user interface.

24. The method of claim 16, further comprising:
presenting options for a plurality of predetermined navigation tasks including the current navigation task;
receiving a user selection of a navigation task among the plurality of predetermined navigation tasks; and
determining the current navigation task based on the user selection.

25. An electronic device, comprising:
a processor; and
a memory coupled to the processor and comprising instructions stored thereon, the instructions when executed by the processor causing the electronic device to perform acts comprising:
generating, for a set of user interface elements, a set of tokens respectively representing the set of user interface elements, the set of user interface elements at least including one or more user interface elements in a current user interface being presented;
transforming the set of tokens into respective feature representations of the set of user interface elements using at least specific information corresponding to a current navigation task;
determining, based on the feature representations, a target element for the current navigation task from the one or more user interface elements; and
performing an operation associated with the target element.

26. The electronic device of claim 25, wherein the set of user interface elements further includes a user interface element that acts as a historical target element in a historical interaction.

27. The electronic device of claim 25, wherein transforming the set of tokens into the respective feature representations comprising:
transforming the set of tokens into at least one set of transformed tokens using shared information for a plurality of predetermined navigation tasks and the specific information, the plurality of predetermined navigation tasks including the current navigation task; and
determining the respective feature representations of the set of user interface elements based on the at least one set of transformed tokens.

28. The electronic device of claim 27, wherein transforming the set of tokens into the at least one set of transformed tokens comprising:
transforming the set of tokens into a set of intermediate tokens using a first shared information item in the shared information; and
transforming the set of intermediate tokens into a set of transformed tokens of the at least one set of transformed tokens using a first specific information item corresponding to the current navigation task in the specific information.

29. The electronic device of claim 27, wherein the at least one set of transformed tokens includes a first set of transformed tokens and a second set of transformed tokens corresponding to the set of user interface elements, and determining the respective feature representations of the set of user interface elements comprising:
obtaining a relative relationship between a first user interface element and a second user interface element of the set of user interface elements;
determining attention information based on the first set of transformed tokens, the second set of transformed tokens and the relative relationship, the attention information indicating correlation between the first user interface element and the second user interface element;
transforming the set of tokens into a third set of transformed tokens corresponding to the set of user interface elements using a second shared information item in the shared information; and
determining the feature representations by weighting the third set of transformed tokens based on the attention information.

30. The electronic device of claim 29, wherein the relative relationship includes at least one of:
a relative encoded position of the first user interface element and the second user interface element obtained from metadata of a user interface, or
a relative spatial position of the first user interface element and the second user interface element.

31. The electronic device of claim 27, wherein determining the target element comprising:
transforming the feature representations using a third shared information item in the shared information and a third specific information item corresponding to the current navigation task in the specific information; and
determining, based on the transformed feature representations, probabilities of the one or more user interface elements being the target element.

32. The electronic device of claim 25, wherein generating a token representing a given user interface element of the set of user interface elements based on at least one of the following of the given user interface element:
a type of the given user interface element,
a text description of the given user interface element,
a position of the given user interface element in a user interface in which the given user interface element is located, or
an occurrence time of the given user interface element relative to the current user interface.

33. The electronic device of claim 25, wherein the acts further comprising:
presenting options for a plurality of predetermined navigation tasks including the current navigation task;
receiving a user selection of a navigation task among the plurality of predetermined navigation tasks; and
determining the current navigation task based on the user selection.

34. A computer program product tangibly stored in a computer storage medium and comprising computer executable instructions that, when executed by a device, cause the device to perform acts comprising:
generating, for a set of user interface elements, a set of tokens respectively representing the set of user interface elements, the set of user interface elements at least including one or more user interface elements in a current user interface being presented;
transforming the set of tokens into respective feature representations of the set of user interface elements using at least specific information corresponding to a current navigation task;
determining, based on the feature representations, a target element for the current navigation task from the one or more user interface elements; and
performing an operation associated with the target element.

35. The computer program product of claim 34, wherein the set of user interface elements further includes a user interface element that acts as a historical target element in a historical interaction.
